(19) United States
(12) Patent Application Publication
(10) Pub. No.: US 2010/0092011 A1
(43) Pub. Date: Apr. 15, 2010

(54) MEMBRANE FOR AN ELECTROACOUSTIC TRANSDUCER AND ACOUSTIC DEVICE

(75) Inventors: Susanne Windischberger, Vienna (AT); Josef Lutz, Rohrau (AT)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP, B.V., Eindhoven (NL)

(21) Appl. No.: 12/515,624

(22) PCT Filed: Nov. 22, 2007
(86) PCT No.: PCT/IB07/54744

§ 371 Date: May 20, 2009

(30) Foreign Application Priority Data
Nov. 23, 2006 (EP) 06077178.9

(51) Int. Cl. H04R 25/00; H04R 7/00

(52) U.S. Cl. 381/190; 181/173

(57) ABSTRACT

A membrane for an electroacoustic transducer is disclosed, wherein said membrane (201) comprises a rigid membrane portion (202) having an edge (203); a flexible membrane portion (204) being connected to the rigid membrane portion (202) along the edge (203); wherein an exterior surface (205) of the flexible membrane portion (204) is concave in an idle state of the membrane (201) and shaped such that a change of the curvature of said exterior surface (205) contributes to an air volume shifted by the rigid membrane portion (202) when membrane (201) is excited.

### FIELD OF THE INVENTION

The invention relates to a membrane for an electroacoustic transducer and to an acoustic device comprising such a membrane.

### BACKGROUND OF THE INVENTION

Because of the ever decreasing size of consumer electronics, loudspeakers and/or microphones have to become smaller as well. Nevertheless, the loudspeakers and/or microphones must provide a sufficient sound pressure respectively a sufficient sensitivity what is a challenging task for the designers of such electro-acoustic transducers.

For the acoustical performance of a speaker, the sound pressure level (SPL) is an important parameter which usually should be as high as possible. In conventional dynamic speakers (see FIG. 1 and FIG. 6), a membrane displaces air and thus produces sound. It comprises two parts, one is relatively compliant and allows the movements of the membrane, the other is rather stiff to effectively displace air. The SPL is given by the displaced air volume, i.e. the displaced area times displacement normal to the area. Because the membrane is fixed to the housing at its borders and thus not translatory moved as a whole, the various sections of a membrane contribute differently to the displaced air volume. Thus, the effective area is always smaller than the total area of the membrane in conventional speaker design. Another important parameter of the speaker is the total harmonic distortion (THD), which should be as low as possible.

US 2002/0148678 discloses several different acoustic radiator designs providing a large baffle, wherein a lesser volume of air is displaced than by the smaller conventional speaker design, while maintaining the same enclosure mouth diameter and allowing the use of a shallower enclosure. A configuration includes a substantially vertically oriented resilient mount for the baffle where that resilient mount is entirely beneath the outer edge of the baffle, between the outer rim of the baffle and the outer flange of the basket, a resilient mount that resembles conventional surround rotated outward by 45° to 70° extending the outer edge of the baffle outward allowing the use of a larger diameter speaker baffle, and surround mounted to the outer flange of the basket beneath the dome of the surround moving the surround outward from the center of the enclosure.

However, known acoustic devices suffer from a weak audio performance, particularly when the acoustic devices are small in size.

### OBJECT AND SUMMARY OF THE INVENTION

It is an object of the invention to provide an acoustic system which has a sufficient audio performance.

In order to achieve the object defined above, an membrane for an acoustic device is provided, the membrane comprising a (relatively) rigid membrane portion having an edge, and a (relatively) flexible membrane portion being connected to the rigid membrane portion along the edge, wherein an exterior surface of the flexible membrane portion is concave in an idle state of the membrane and shaped such that a change of the curvature of said exterior surface contributes to an air volume shifted (or moved) by the rigid membrane portion when membrane is excited.

In order to achieve the object defined above, furthermore an acoustic device is provided comprising a membrane having the above mentioned features.

The term “oscillatory membrane” denotes any single-layer or multi-layer diaphragm which may oscillate under the influence of a force and thereby generates sound. However, such an oscillatory membrane can also absorb sound and convert it into mechanical oscillations for supply to a transducing element. A compound membrane may be formed of a plurality of different components and/or materials, for instance of thermoplastic or other materials.

The term “acoustic device” denotes any apparatus which is capable of generating sound for emission to an environment and/or for the detection of acoustic waves present in the environment. Such an acoustic device includes any electromechanical transducer capable of generating sound based on electric signals, or vice versa.

The term “rigid membrane portion” particularly denotes a membrane portion which remains essentially non-deformed under the influence of a mechanical force of a strength which is commonly drawn on a diaphragm by a loudspeaker drive unit. Such a rigid membrane portion may have a value of Young's modulus in the range of 3 GPa to 5 GPa. The rigid (or stiff) membrane may have a thickness of between essentially 1 μm and essentially 100 μm, particularly of between essentially 6 μm and essentially 50 μm, or up to several 100 μm. The rigid membrane portion may be a plate-like member and may be made by casting or molding. It can comprise a metal like Aluminum or a plastic material. In a compound configuration, the rigid membrane can comprise multiple layers, for instance two Aluminum layers sandwiching a foam layer positioned in between the two surrounding layers.

The term “flexible membrane portion” particularly denotes a membrane portion which is deformed to a considerable extent under the influence of a mechanical force of a strength which is commonly drawn on a diaphragm by a loudspeaker drive unit. Such a flexible membrane portion may have a value of Young's modulus in the range of 0.1 GPa to 3 GPa. The flexible (or elastic) membrane may have a thickness of between essentially 1 μm and essentially 100 μm, particularly of between essentially 6 μm and essentially 40 μm. The flexible membrane can comprise any plastic material (like polycarbonate), or can be made of silicone (for instance a material of a group of semi-inorganic polymers based on the structural unit R₂SiO, where R is an organic group). The flexible membrane can be made by casting or molding.

The term “Young's modulus” denotes a modulus of elasticity describing a material property or parameter which is equal to a ratio between a mechanical tension and a corresponding elongation and thus a measure of the stiffness of a material. Therefore, rigid materials have a larger value of Young's modulus than flexible materials. The Young's modulus may also be denoted as the modulus of elasticity, elastic modulus or tensile modulus.

The term “exterior surface of the membrane” particularly denotes a surface portion of the membrane which is directed or oriented towards a sound emission target of a loudspeaker or a sound source detected by a microphone. By contrast, an interior surface of the flexible membrane is arranged opposite the exterior surface and often is directed towards an transducing element of a loudspeaker or a microphone.

The term “concave curvature” particularly denotes a shape of a cross-section of the flexible membrane portion in a direction perpendicular to the rigid membrane portion which forms an indentation of the flexible membrane portion along a closed line of the flexible portion surrounding the rigid portion. As a consequence, the membrane may be essentially wheel-rim shaped, as shown for instance in FIG. 5. A wheel-rim shape may be formed by forming a indentation into the curved surface of a cylindrical body, wherein the curved cylindrical portion then represents the flexible membrane portion. A planar portion of such a cylinder may then represent the rigid membrane portion.

The term “idle state of the membrane” denotes a state of the membrane in the absence of external forces, that is an equilibrium state. The membrane may oscillate between an upper dead point (or end point) of the oscillatory motion and a lower dead point of the oscillatory motion, during a duty cycle.

The term “electrodynamic acoustic device” denotes an acoustic device which converts acoustic waves into electric signals, or vice versa, using an electromagnetic principle, for instance a coil and a magnet configuration.

The term “piezoelectric acoustic device” denotes an acoustic device which is based on the piezoelectric effect. For instance, such a device is adapted as a piezoelectric microphone. A piezoelectric microphone uses the phenomenon of piezoelectricity—the property of some materials to produce an electric voltage when subjected to a mechanical pressure, or vice versa—to convert vibrations into an electrical signal. However, the device can also be adapted as a piezoelectric loudspeaker based on the phenomenon of piezoelectricity.

According to the invention, a diaphragm for a loudspeaker or a microphone is provided having a non-flexible portion and having an elastic portion. The elastic portion is arced or curved in a manner to expose a resulting indentation towards an exterior observer.

When a transducing element (e.g. a coil attached to the membrane being in a magnetic field) excites the membrane (i.e. the rigid and the flexible parts in common), the rigid part is moved in a manner to essentially maintain its shape (i.e. translatory moved), whereas the value of the curvature of the flexible portion is changed, so that both the rigid and the flexible portion of the membrane contribute to a volume of a shifted air. Therefore, it is possible to increase the sound pressure level (SPL) and thus improve the performance of an acoustic device significantly. This is particularly advantageous for the design of small dimensioned acoustic devices, for instance for loudspeakers of mobile phones. Such small dimensioned acoustic devices usually suffer from a non-sufficient loudness. Because according to the invention also the flexible portion contributes to the moved air volume, it is possible to obtain a higher sound pressure with the same size of the membrane. Alternatively, the same sound pressure can be obtained with a smaller size of the membrane. This allows to manufacture miniaturized acoustic devices.

Next, advantageous embodiments of the membrane and the acoustic device will be explained. It should be noted that the embodiments, which are presented in relation to the inventive membrane, also apply to the acoustic device and vice versa.

The rigid membrane portion may be essentially perpendicular to the flexible membrane portion. This geometry may be particularly of advantage when an increase of the displaced air volume is desired. Therefore, such a configuration may yield a large SPL. In this case the effective area of the membrane is (almost) 100% of the membrane area, however, at least higher than the area of the rigid membrane portion.

The rigid membrane portion may be essentially planar. Therefore, the rigid membrane portion may function in a similar manner as a piston shifting a large amount of air in an upward direction. Furthermore, a planar surface is easy to manufacture so that the membrane may be, in its entirety, easy to manufacture. Beyond this, a planar geometry may allow to manufacture the membrane in a flat and space-saving manner. Thus, the manufacture of flat loudspeakers with proper audio performance is possible. Alternatively, the rigid portion may have any other desired shape, like a bent or curved shape.

The flexible membrane portion may be essentially wheel-rim shaped. Such a wheel-rim is shown, for instance, in FIG. 5. “Wheel-rim shaped” denotes the shape of a deformed cylinder in which the curved surface of the cylinder is arced, or an indentation, particularly with an elliptic shape, is formed into the curved portion. Such a configuration is mechanically stable, easy to manufacture and contributes significantly to the shifted air volume, thereby achieving a proper performance of the loudspeaker.

The exterior surface of the flexible membrane portion may have, in an idle (or equilibrium) state of the membrane, a semi-elliptic curvature. In other words, in a cross-section of the flexible membrane portion, two (symmetric) half ellipses may be visible with the ellipse minima being directed opposing one another. Such a semi-elliptic curvature is a proper geometry to shift a huge amount of air, by the flexible portion.

The exterior surface of the flexible membrane portion may have, in an idle state of the membrane, a semi-elliptic curvature with a larger half axis being oriented essentially perpendicular to the rigid membrane portion (and thus in movement direction of the rigid membrane portion provided that the flexible and the rigid portion are perpendicular to each other). Therefore, in a cross-sectional view, this small half axis of the two semi-ellipses are oriented essentially parallel to the planar rigid surface. The large half-axis of the two half-ellipses are oriented essentially parallel to one another, and perpendicular to the surface of the rigid membrane portion. Such a geometry is capable of yielding a proper acoustic performance. When the rigid membrane portion moves in an upward direction, the longer half axis is extended or lengthened. When the rigid membrane portion moves in a downward direction, the longer half axis is shortened. An upward direction may be a direction in which a distance between the rigid portion and the housing of an electroacoustic transducer is increased, whereas a downward direction corresponds to a state in which the rigid portion approaches said housing. In an idle state of the membrane, the maximum distance between the upper and the lower dead point is advantageously smaller than or equal to essentially one fifth of the length of the longer half axis of an elliptically shaped flexible membrane. The smaller half axis of an elliptically shaped flexible membrane is advantageously essentially half of the longer half axis.

It is advantageous if an exterior surface of the flexible membrane portion has, in a lower dead point of the membrane (that is to say when the flexible membrane portion is compressed to a maximum extent), a semi-circular curvature. A lower dead point is a reversion point in which the membrane motion changes from a downward motion to an upward motion. When the lower dead point of the membrane coincides with a semi-circular shape of the flexible membrane portion, an efficient air volume shift over an entire duty cycle is obtained. When the rigid membrane portion moves beyond said optimum lower dead point the smaller half axis becomes the longer half axis, which is then essentially normal to the motion direction of the loudspeaker. In this state, no additional sound is generated. Even worse, the loudspeaker becomes more quiet since the air stream caused by the flexible membrane portion changes its direction.

The membrane may further be adapted in such a manner that a total harmonic distortion of the flexible membrane portion is essentially compensated by a total harmonic distortion of the rigid membrane portion. In some cases, the membrane is designed such that the total THD is as small as possible. Since the THD of the flexible membrane portion is, in a rough approximation, independent of THD which is generated by the motion of the rigid portion of the membrane, the THD of the rigid portion can (partially or entirely) be compensated by the THD of the flexible portion. Accordingly, the total THD (of the entire membrane) can be made as small as possible. For this reason, the length of the semi-major axis is adjusted accordingly. In this case, it may also be advantageous if the membrane moves beyond the lower dead centre given by the half circle shape of the flexible membrane portion. Therefore, exemplary embodiments of the invention may allow to obtain more SPL with smaller loudspeakers, and/or a compensation of THD. Such advantages may be particularly obtained in loudspeakers or receivers. For such embodiments, the materials of membrane, the thickness of the membrane portions, and the geometric shapes of the membrane portions are adjusted accordingly. This allows to obtain a loudspeaker with a proper audio performance and quality.

The acoustic device may comprise a coil arranged at an interior or at an exterior surface of the rigid membrane portion. According to one embodiment, the coil is attached to an inner surface of the rigid membrane portion so as to be invisible from an exterior side. According to another exemplary embodiment, the coil may be positioned outside of the rigid membrane portion, that is to say visible from an outside portion. In both embodiments, the coil is energized using electrical signals to render audio content. The magnetic field generated in such a coil interacts with magnets positioned in an interior of the acoustic device to generate electromagnetic forces moving the membrane in any desired direction. Consequently, acoustic waves are generated.

The acoustic apparatus may be realized as at least one of the group consisting of a handheld sound reproduction system, a wearable device, a near-field sound reproduction system, headphones, earphones, a portable audio player, an audio surround system, a mobile phone, a headset, a hearing aid, a hands free system, a television device, a TV set audio player, a video recorder, a monitor, a gaming device, a laptop, a DVD player, a CD player, a hard disk based media player, an internet radio device, a public entertainment device, an MP3 player, a hi-fi system, a vehicle entertainment device, a car entertainment device, a medical communication system, a speech communication device, a home cinema system, a home theater system, a flat television apparatus, an ambiance creation device, and a music hall system.

The aspects defined above and further aspects of the invention are apparent from the examples of embodiment to be described hereinafter and are explained with reference to these examples of embodiment.

### BRIEF DESCRIPTION OF THE DRAWINGS

The invention will be described in more detail hereinafter with reference to examples of embodiment but to which the invention is not limited.

FIG. 1 shows a conventional acoustic device.

FIG. 2 shows an acoustic device according to an exemplary embodiment of the invention.

FIG. 3 and FIG. 4 show an enlarged view of a portion of an acoustic device according to an exemplary embodiment of the invention in two different operation states.

FIG. 5 shows a three-dimensional view and a cross sectional view of an oscillatory membrane according to an exemplary embodiment of the invention.

FIG. 6 shows a three-dimensional view and a cross sectional view of a conventional oscillatory membrane.

### DESCRIPTION OF EMBODIMENTS

The illustration in the drawing is schematically. In different drawings, similar or identical elements are provided with the same reference signs.

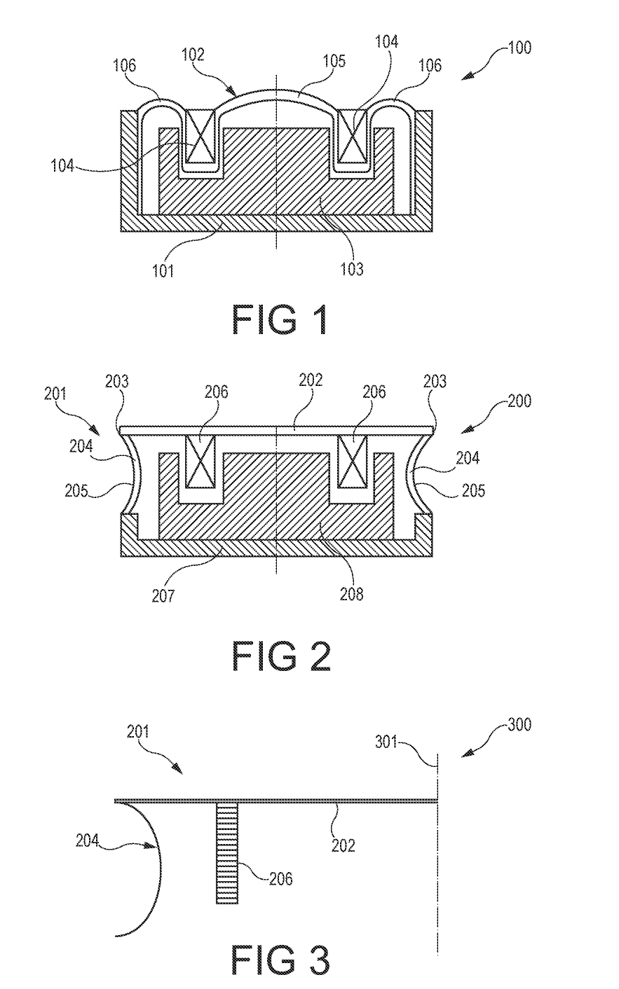

FIG. 1 shows a conventional speaker 100 (e.g. for mobile phones) comprising a housing 101, a membrane 102, a magnet 103 and a coil 104. The membrane 102 comprises a rigid portion 105 which moves piston-like and a spring portion 106 which through its deformation allows a movement of the rigid portion 105.

FIG. 2 shows a speaker 200 according to an embodiment of the invention. The loudspeaker 200 comprises a compound membrane 201 formed by two layers. These layers can be made of thermoplastic materials, for instance. However, also a single layer configuration of the membrane 201 is possible. Furthermore, FIG. 2 shows a housing or base member 207 and a magnetic arrangement 208. The base element 207 (which may also be denoted as a basket) may be made of any appropriate material, like metal or plastics, for instance polycarbonate.

The magnetic arrangement 208 cooperates with a coil 206. When the coil 206 is activated by an electric audio signal, an electromagnetic force occurs between the coil 206 and the magnetic system 208. This excites the membrane 201 in accordance with the exciting acoustic signals, thereby generating acoustic waves which are emitted to an environment perceivable by a human listener.

A portion 202 of the compound membrane 201 positioned within the coil 206 is relatively rigid, i.e. it is not substantially deformed when the coil 206 is excited by an audio signal. A portion 204 of the compound membrane 201 being positioned close to vertical portions of the base member 207 is relatively flexible, i.e. it is substantially deformed when the coil 206 is excited by an audio signal.

A thickness of the rigid portion 202 may be larger than a thickness of the flexible portion 204. It is also possible that the rigid portion 202 and the flexible portion 204 are made of the same material and/or of the same thickness, and that different degrees of rigidity/flexibility may be obtained by different geometries. Furthermore, the Young's modulus of elasticity of the rigid portion 202 may be higher than the Young's modulus of the flexible portion 204.

As an alternative to the loudspeaker 200, the compound membrane 201 may also be implemented in a microphone, or any other acoustic device.

In more detail, the oscillatory membrane 201 comprises the rigid membrane portion 202 having an edge 203. Furthermore, the flexible membrane portion 204 is connected to the rigid membrane portion 202 along the edge 203. An exterior lateral surface 205 of the flexible membrane portion 204 has, in an idle state of the membrane 201 (that is to say in a state in which it is not excited) 201, a concave curvature shaped to contribute to an air volume shifted by the rigid membrane portion 202 when the membrane 201 is excited.

As can be seen in FIG. 2, the rigid membrane portion 202 is oriented essentially perpendicular to the flexible membrane portion 204. In other words, a vertical extension of the flexible portion 204 is essentially perpendicular to the horizontal orientation of the planar rigid portion 202. FIG. 2 shows a cross-sectional area of the loudspeaker 200. A corresponding schematic perspective illustration is given in FIG. 5. In such a three-dimensional illustration, one can see the flexible portion 204 of the membrane being essentially shaped like a wheel-rim of an automobile wheel.

By contrast, a conventional membrane has a central portion 105 and two essentially convex shaped flexible portions 106 as indicated in FIG. 6.

FIG. 2 shows the speaker 200 in which the rigid portion 202 and the flexible membrane portion 204 are arranged perpendicular to each other. When the membrane 201 moves upwards, the flexible membrane portion 204 is elongated so that the shifted volume and thus the sound pressure is increased. When the membrane 201 moves downwards, the flexible membrane portion 204 is compressed so that it sucks in air so to speak and so that the shifted volume and thus the sound pressure is increased again.

Thus, FIG. 2 shows an electroacoustic transducer (a speaker, but a configuration as a microphone is possible as well) comprising the membrane 201 with the rigid portion 202 and the flexible membrane portion 204 arranged perpendicular to each other, wherein the flexible membrane portion 204 has an elliptic cross-section in the idle position of the membrane 200 as it is shown in FIG. 2.

FIG. 3 shows a cross-sectional view of a membrane 201 (attached with a coil 206) according to an embodiment of the invention. Only the left half of the symmetric configuration is shown, as indicated by a symmetry line 301. In FIG. 3, the membrane 201 is in the idle state. The rigid portion 202 may also be denoted as a dome, wherein the flexible portion 204 may also be denoted as a fringe. A product as shown in FIG. 3 can be an intermediate product for a speaker or a microphone.

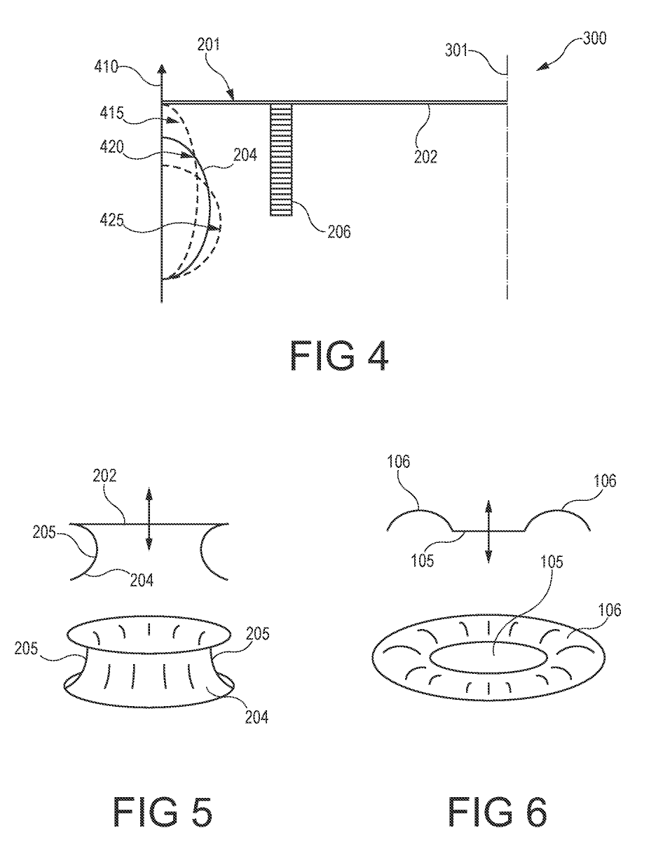

FIG. 4 shows the speaker 300 in different operation modes, wherein the flexible portion 204 is shaped for a proper air displacement capability. In FIG. 4, the flexible membrane portion 204 is shown in three operation states. A direction of the movement of the membrane 201 is indicated along an ordinate 410. In a first operation mode 415, the membrane 201 is in the highest position and the flexible portion 204 is in an elongated state. In a second configuration 420, the membrane 201 and particularly the flexible portion 204 thereof is in an equilibrium or idle position. In the configuration 420, the shape is elliptic. In a third operation state indicated with reference numeral 425, the flexible portion 204 is in a lowest, compressed position and has a semi-circular shape.

FIG. 4 shows an exemplary embodiment of the invention (half section of a schematic speaker 300) in detail. The flexible membrane portion 204 has an elliptic cross-section in the idle position 420 with a major axis arranged in the movement direction of the rigid portion 201. When the rigid portion 201 moves upward, the ellipse is elongated. When it moves downward, the ellipse is compressed. In an advantageous embodiment, the cross-section of the flexible membrane portion 204 is a half circle in the lower dead centre. In a further advantageous embodiment, the total harmonic distortion (THD) of the rigid portion 202 is compensated by the THD of the flexible membrane portion 204.

Finally, it should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The use of the verb “comprise” and its conjugations do not exclude the presence of elements or steps other than those listed in any claim or the specification as a whole. The singular reference of an element does not exclude the plural reference of such elements and vice-versa. In a device claim enumerating several means, several of these means may be embodied by one and the same item of software or hardware. The mere fact that certain measures are recited in mutually different dependent claims does not indicate that a combination of these measures cannot be used to advantage.

1. A membrane for an acoustic device, the membrane comprising
a rigid membrane portion having an edge;
a flexible membrane portion being connected to the rigid membrane portion along the edge;
wherein an exterior surface of the flexible membrane portion is concave in an idle state of the membrane and shaped such that a change of the curvature of said exterior surface contributes to an air volume shifted by the rigid membrane portion when membrane is excited.

2. The membrane according to claim 1, wherein the rigid membrane portion is oriented essentially perpendicular to the flexible membrane portion.

3. The membrane according to claim 1, wherein the flexible membrane portion is essentially wheel-rim shaped.

4. The membrane according to claim 1, wherein a cross-section of the exterior surface of the flexible membrane portion has, in the idle state of the membrane, a shape of a half ellipse.

5. The membrane according to claim 4, wherein the half ellipse has a larger half axis being oriented essentially perpendicular to the rigid membrane portion.

6. The membrane according to claim 1, wherein a cross-section of the exterior surface of the flexible membrane portion has, in a lower dead point of the membrane, a shape of a half circle.

7. The membrane according to claim 1, being designed in such a manner that a total harmonic distortion of the flexible membrane portion is essentially compensated by a total harmonic distortion of the rigid membrane portion.

8. The membrane according to claim 1, internal to an acoustic device which is an electroacoustic transducer device, an electrodynamic acoustic device, a piezoelectric acoustic device, a speaker, a microphone, a receiver, or a vibrator.

9. The membrane according to claim 8, wherein the acoustic device is a transducing element attached to the membrane.

10. The membrane according to claim 8, wherein the acoustic device is a handheld sound reproduction system, a wearable device, a near-field sound reproduction system, headphones, earphones, a portable audio player, an audio surround system, a mobile phone, a headset, a hearing aid, a hands free system, a television device, a TV set audio player, a video recorder, a monitor, a gaming device, a laptop, a DVD player, a CD player, a hard disk based media player, an Internet radio device, a public entertainment device, an MP3 player, a hi-fi system, a vehicle entertainment device, a car entertainment device, a medical communication system, a speech communication device, a home cinema system, a home theater system, a flat television apparatus, an ambiance creation device, or a music hall system.
